(19) United States
(12) Patent Application Publication
(10) Pub. No.: US 2025/0214272 A1
(43) Pub. Date: Jul. 3, 2025

(54) DEVICE FOR ASSEMBLING A CUTTING-BED SUPPORT ELEMENT ON A BATTEN OF A CONVEYOR-TYPE CUTTING MACHINE

(71) Applicant: LECTRA, Paris (FR)

(72) Inventors: Regis LALLEMENT, Cestas (FR); Didier CHABIRAND, Cestas (FR); Quentin COSSON-COCHE, Le Pian Sur Garonne (FR)

(21) Appl. No.: 18/853,502

(22) PCT Filed: Apr. 4, 2023
(86) PCT No.: PCT/FR2023/050485

§ 371 Date: Oct. 2, 2024

(30) Foreign Application Priority Data
Apr. 7, 2022 (FR) FR2203213

(51) Int. Cl. B26D 7/20; B26D 7/06; B26D 7/08

(52) U.S. Cl. CPC B26D 7/20; B26D 7/0625; B26D 7/086

(57) ABSTRACT

A device is for assembling a modular cutting support element on a cutting support batten of a conveyor cutting machine for cutting sheet materials, and includes a cutting support batten, at least one modular cutting support element comprising a plurality of bristles each having a foot secured to a baseplate and a head opposite to the foot, and means for vertically holding by magnetism at least a second lateral end of the baseplate of the modular cutting support element on at least a second lateral end of the cutting support batten.

### TECHNICAL FIELD

The present invention relates to the general field of suction cutting supports for an automatic cutting machine for cutting sheet materials, in particular textile materials, using a vibrating blade penetrating into the cutting support. It concerns more specifically a device for assembling such a cutting support element on a batten of a conveyor cutting machine.

One field of application of the invention is that of the automatic cutting of stacks or mats of sheets of materials, in particular textile materials, using a vibrating blade penetrating into a suction cutting support.

### PRIOR ART

A vibrating blade cutting machine comprises in particular a cutting conveyor which is used to drive the stack of sheets during the cutting operation. This cutting conveyor is housed in a box inside which a strong depression is established in order to keep the sheets of material to be cut stationary during the cutting operation.

In this type of machine, the cutting conveyor also serves as a penetrating cutting support for the vibrating blade. It is indeed well known to make the cutting support penetrable by the blade so that during the cutting operation, the blade can not only completely pass through the material to be cut, but also extend downward beyond the support surface and in the bed of material providing such a surface.

To do so, the cutting support is generally made up of an assembly of blocks mounted on cutting support battens which are themselves installed in the conveyor and driven by a belt. More specifically, each block comprises a plurality of bristles mounted on a baseplate in several parallel rows, each bristle having a head forming the support for the sheet material to be cut. Transverse channels are made through the baseplate to allow the passage of suction air. These blocks thus make it possible to support the material to be cut under suction while being able to be penetrated by the cutting blade.

Alternatively, cutting supports made by mounting a plurality of modular comb elements on cutting support battens have been developed. it is possible in particular to refer to the publication WO 2021/191522 which describes one exemplary embodiment of modular comb elements comprising a plurality of bristles arranged in the same and single line, which makes it possible to give at least some bristles a head having a straight section encompassing a straight section of the stem, while retaining the ability to manufacture these modular elements by molding in a single piece with their baseplate and their bristles. Such a geometric shape of the bristles thus has the advantage of limiting the interactions between the tip of the cutting blade and the bristles in tangency.

Whatever their embodiment, the blocks or the modular comb elements are generally assembled on the cutting support battens via hook-shaped fasteners which are inserted into slides formed in the battens.

The consequence of this type of assembly is that it is necessary to completely dismount the battens installed in the conveyor as soon as it is wished to extract a damaged block (or a modular comb element) to replace it with a new one. The replacement of a block (or of a modular comb element) is thus made particularly tedious.

### Disclosure of the Invention

The present invention therefore aims to propose a device for assembling a modular cutting support element on a cutting support batten which does not have the aforementioned drawbacks.

In accordance with the invention, this aim is achieved thanks to a device for assembling a modular cutting support element on a cutting support batten of a conveyor cutting machine for cutting sheet materials, comprising:
a cutting support batten intended to be secured to a conveyor of the cutting machine,
at least one modular cutting support element comprising a plurality of bristles each having a foot secured to a baseplate and a head opposite to the foot on which a sheet material to be cut is intended to rest, and
means for vertically holding by magnetism at least part of the baseplate of the modular cutting support element on at least part of the cutting support batten.

The device according to the invention is remarkable in that the vertical holding of the modular cutting support element (namely cutting support block or modular comb element) is achieved by magnetism. When it is necessary to extract the modular cutting support element from the cutting support batten (for example to replace it with a new modular element), it is simply pulled vertically to cancel the magnetic effect and separate it from the cutting support batten. Particularly, this device makes it possible to ensure a dismounting of a modular cutting support element without having to dismount beforehand the cutting support batten, the modular cutting support element being held in position on the batten by magnetism and by a hook.

Advantageously, the cutting support batten comprises at a first lateral end a hook and the baseplate of the modular cutting support element comprises at a first lateral end a hook able to cooperate with the hook of the cutting support batten to ensure the lateral and vertical holding of the modular cutting support element on the cutting support batten.

In this configuration, the first lateral end of the device allows the lateral and vertical holding of the modular cutting support element on the batten and opposes the forces that the modular cutting support element undergoes during all the phases of operation.

Also advantageously, the device further comprises means for laterally holding a second lateral end of the baseplate of the modular cutting support element against a second lateral end of the cutting support batten.

In this case, the second lateral end of the baseplate of the modular cutting support element can comprise a protruding lug and the second lateral end of the support batten can comprise a protruding abutment able to cooperate with the lug of the baseplate of the modular cutting support element so as to allow lateral holding of the second lateral end of the baseplate of the modular cutting support element against the second lateral end of the cutting support batten.

Alternatively, the second lateral end of the baseplate of the modular cutting support element can comprise a recessed notch and the second lateral end of the support batten can comprise a protruding abutment able to cooperate with the notch of the baseplate of the modular cutting support element so as to allow lateral holding of the second lateral end of the baseplate of the modular cutting support element against the second lateral end of the cutting support batten.

According to one embodiment, the baseplate of the modular cutting support element comprises a magnet positioned at least at its second lateral end and the cutting support batten comprises a metal insert positioned at least at its second lateral end so as to allow vertical holding by magnetism of the second lateral end of the baseplate of the modular cutting support element on the second lateral end of the cutting support batten.

In this case, the magnet of the baseplate of the modular cutting support element may be common for a plurality of adjacent modular cutting support elements.

In addition, the magnet can extend between the two lateral ends of the modular cutting support element and be provided with holes for the passage of air.

According to another embodiment, the baseplate of the modular cutting support element comprises a metal insert positioned at least at its second lateral end and the cutting support batten comprises a magnet positioned at least at its second lateral end so as to allow vertical holding by magnetism of the second lateral end of the baseplate of the modular cutting support element on the second lateral end of the cutting support batten.

Preferably, the first lateral end of the cutting support batten corresponds to an upstream end relative to the direction of advance of the conveyor of the cutting machine.

Advantageously, the first lateral end of the baseplate of the modular cutting support element further comprises contactless identification means.

The modular cutting support element may be a modular comb element or a cutting support block.

### BRIEF DESCRIPTION OF THE DRAWINGS

FIG. 1 is a sectional view of an assembly device according to one embodiment of the invention.

FIG. 2 is a sectional view of an assembly device according to another embodiment of the invention.

FIG. 3 is a sectional view of an assembly device according to yet another embodiment of the invention.

FIG. 4 is a sectional view of an assembly device according to yet another embodiment of the invention.

FIG. 5 is a sectional view of an assembly device according to yet another embodiment of the invention.

### DESCRIPTION OF THE EMBODIMENTS

The present invention relates to the cutting supports for a suction cutting conveyor of a machine for automatically cutting sheet materials by blade.

Typically, a cutting conveyor is used to drive the stack of sheets during the cutting operation. This cutting conveyor is generally housed in a box inside which a strong depression is established in order to keep the sheets of material to be cut stationary during the cutting operation.

Moreover, the cutting conveyor serves as a penetrating cutting support for the vibrating blade. It is indeed necessary to make the cutting support penetrable by the blade so that during the cutting operation, the blade can not only completely pass through the material to be cut, but also extend downward beyond the support surface and in the bed of material providing such a surface.

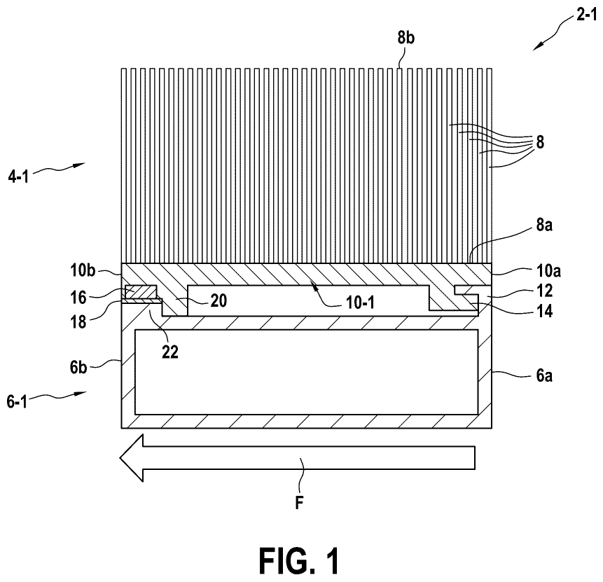

As represented in FIG. 1, the cutting conveyor generally comprises a plurality of cutting supports 2-1 each composed of a cutting support block 4-1 which is mounted on a cutting support batten 6-1, the latter being itself installed in the conveyor and driven by a belt.

The cutting support block 6-1 can be replaced by a unitary comb element as described in detail in patent application WO 2021/191522, whose content is integrated here by reference.

More specifically, each cutting support block 4-1 (or unitary comb element) comprises a plurality of bristles 8 each having a foot 8a mounted on a baseplate 10-1 by forming one or several parallel rows of bristles, and a head 8b opposite to the foot and on which the sheet material to be cut is intended to rest. In known manner, the baseplate 10-1 is provided with holes (not represented in the figures) allowing the passage of suction air.

According to the invention, each cutting support block 4-1 (or unitary comb element) is assembled on a cutting support batten 6-1, at a first lateral end by lateral and vertical mechanical holding means, and at a second lateral end (opposite to the first end), on the one hand by vertical holding means by magnetism and, on the other hand, by mechanical lateral holding means.

In the embodiments of FIGS. 1 to 3, the first lateral end of the cutting support blocks 6-1 corresponds to their upstream end with respect to the direction of advance F of the conveyor of the cutting machine, and the second lateral end corresponds to their downstream end (still in the direction of advance F of the conveyor).

Still in these different embodiments, the mechanical lateral and vertical holding means at the level of the first lateral end of the cutting support blocks 6-1 are formed by cooperation between complementary hooks.

More specifically, the first lateral end 6a of the cutting support batten 6-1 is provided with a hook 12 at the level of its upper face which is open downstream (relative to the direction of advance F of the conveyor).

Likewise, the cutting support block 4-1 (or the unitary comb element) is provided, at the level of the lower face of the first lateral end 10a of its baseplate 10-1, with a hook 14 which is open towards the upstream and which cooperates with the hook 12 of the cutting support batten to ensure mechanical holding of the cutting support block both laterally and vertically.

At the level of the second lateral end 6a of the cutting support batten, the vertical holding of the cutting support block is achieved by magnetism.

In the embodiment of FIG. 1, this holding by magnetism is achieved by means, on the one hand, of a metal insert 16 which is positioned at the level of (or even integrated into) the lower face of the second lateral end 10b of the baseplate 10-1 of the cutting support block (or of the unitary comb element), and on the other hand by a magnet 18 which is positioned at the level of (or integrated into) the upper face of the second lateral end 6a of the support batten 6-1.

Thus, the magnet 18 and the metal insert 16 cooperate with each other by magnetism to allow vertical holding of the cutting support block (or of the unitary comb element) on the cutting support batten at the level of their respective second lateral end.

It will be noted that, when it comes to a cutting support block, the metal insert does not necessarily extend over the entire length thereof (it can cover only part of the length of the cutting support block).

In addition, when it comes to a plurality of unitary comb elements, it will be necessary to provide for a metal insert for each unitary comb element.

Still in this embodiment, the lateral holding of the cutting support block 4-1 on the cutting support batten 6-1 is achieved by mechanical means.

For this purpose, in the embodiment of FIG. 1, the second lateral end 10b of the baseplate 10-1 of the cutting support block 4-1 comprises a lug 20 which is protruding inwards, and the second lateral end 6b of the support batten 6-1 comprises an abutment 22 which is protruding outwards and which is able to cooperate with the lug 20 of the baseplate of the cutting support block so as to allow mechanical lateral holding of the cutting support block against the cutting support batten at the level of their respective second lateral end.

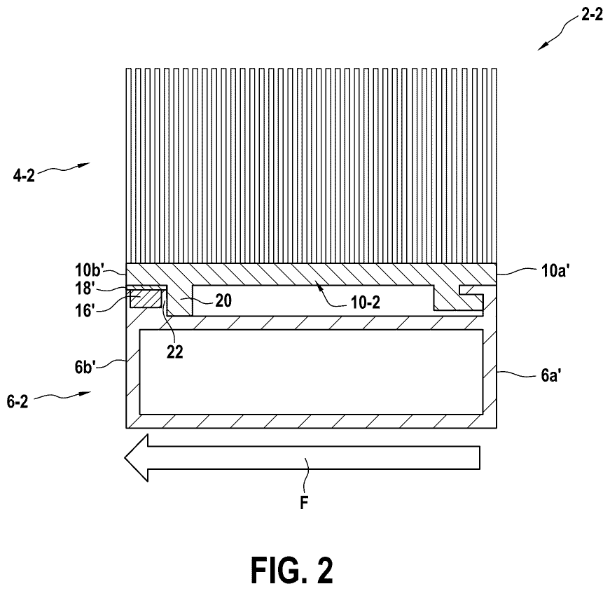

In relation to FIG. 2, another embodiment of the assembly device 2-2 according to the invention will now be described.

This embodiment differs from the one previously described by the means for vertically holding by magnetism the second lateral end 10b′ of the baseplate 10-2 of the cutting support block 4-2 (or of the unitary comb element) on the second lateral end 6b′ of the cutting support batten 6-2.

Indeed, in this other embodiment, the holding by magnetism is achieved by means, on the one hand, of a metal insert 16′ which is positioned at the level of (or even integrated into) the lower face of the second lateral end 6a′ of the support batten 6-2, and on the other hand by a magnet 18′ which is positioned at the level of (or even integrated into) the upper face of the second lateral end 10b′ of the baseplate 10-2 of the cutting support block (or of the unitary comb element).

It is therefore a magnet-metal insert configuration which is reverse compared to the one described in relation to the embodiment of FIG. 1.

Moreover, in this embodiment, the magnet 18′ can extend between the two lateral ends 10b′ of the baseplate 10-2 of the cutting support block (or of the unitary comb element). In this case, the magnet will also be provided with holes to allow the passage of suction air.

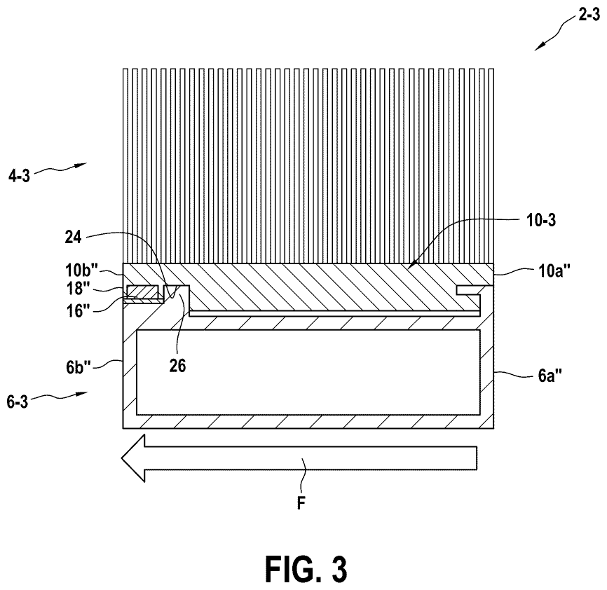

In relation to FIG. 3, yet another embodiment of the assembly device 2-3 according to the invention will now be described.

This embodiment differs from the two previous ones by the means for laterally holding the cutting support block 4-3 on the cutting support batten 6-3 at the level of their respective second lateral end.

Indeed, in this embodiment, the second lateral end 10b″ of the baseplate 10-3 of the cutting support block 4-3 (or of the unitary comb element) comprises a notch 24 on its interior face which is recessed and the second lateral end 6b″ of the support batten 6-3 comprises an abutment 26 which is protruding outwards and which is able to cooperate with the notch 24 of the baseplate of the cutting support block so as to allow lateral holding of the cutting support block against the cutting support batten at the level of their respective second lateral end.

It will be noted that in this embodiment, the means for vertically holding by magnetism the second lateral end 10b″ of the baseplate 10-3 of the cutting support block 4-3 (or of the unitary comb element) on the second lateral end 6b″ of the cutting support batten 6-3 may be similar to those described in relation to FIG. 1 (and as represented in FIG. 3) or, alternatively, be similar to those described in relation to FIG. 2.

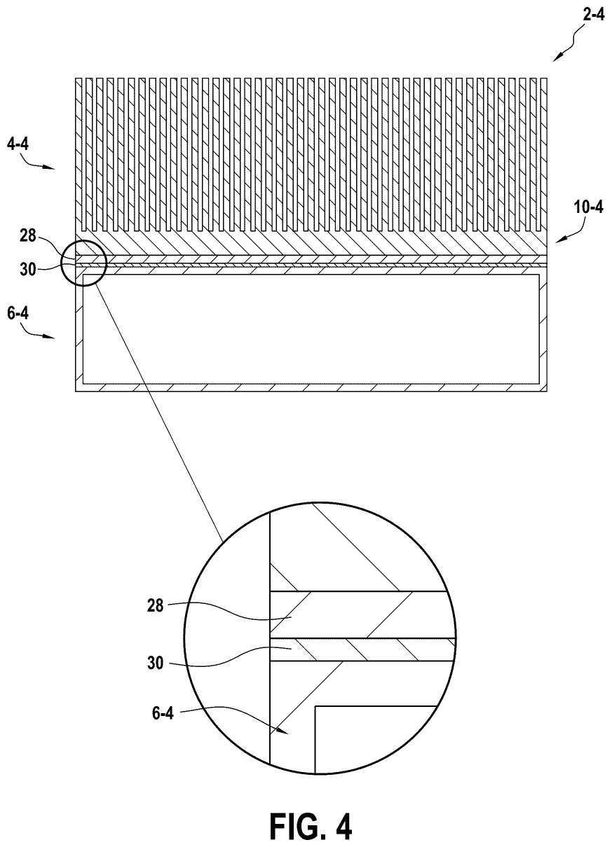

In relation to FIG. 4, yet another embodiment of the assembly device 2-4 according to the invention will now be described.

In this embodiment, the vertical holding by magnetism of the baseplate 10-4 of the cutting support block 4-4 (or of the unitary comb element) on the cutting support batten 6-4 is achieved in particular by a magnet 28 which is positioned at the level of (or integrated into) the lower face of the baseplate of the cutting support block (or of the unitary comb element) over the entire width thereof (that is to say between its two lateral ends).

In addition, a metal insert 30 is positioned at the level of (or even integrated into) the upper face of the support batten 6-4 over the entire width thereof (that is to say between its two lateral ends).

Thus, the magnet 28 and the metal insert cooperate with each other by magnetism to ensure the holding of the cutting support block 4-4 (or of the unitary comb element) on the cutting support batten 6-4.

Of course, in this embodiment, the magnet 28 of the baseplate of the cutting support block 4-4 (or of the unitary comb element) is provided with holes (not represented in the figure) to allow the passage of suction air.

Moreover, in this embodiment, the assembly device does not have a hook at the level of the first lateral end of the cutting support block 4-4 (or of the unitary comb element) and of the cutting support batten 6-4.

Likewise, the assembly device of this embodiment does not have mechanical means to ensure lateral holding of a second lateral end of the baseplate of the cutting support block (or of the unitary comb element) against a second lateral end of the cutting support batten.

Indeed, in this embodiment, the sole magnetic force of attraction of the magnet 38 makes it possible to ensure this lateral holding function in addition to the vertical holding.

Of course, in this embodiment, it is possible to envisage a reverse arrangement of the magnet and of the metal insert, that is to say to have the magnet integrated into the upper surface of the cutting support batten, and the metal insert integrated into the lower surface of the cutting support block (or of the unitary comb element).

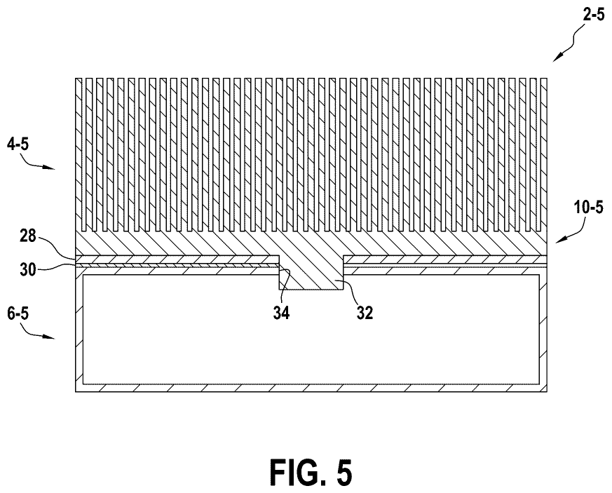

In relation to FIG. 5, yet another embodiment of the assembly device 2-5 according to the invention will now be described.

This embodiment differs from the one previously described in that the baseplate 10-5 of the cutting support block 4-5 (or of the unitary comb element) comprises, between its two lateral ends, a finger 32 protruding inwards and able to be housed in a notch 34 formed in the cutting support batten 6-5 so as to ensure a translational stop of the cutting support block (or of the unitary comb element).

Of course, it is possible to envisage a reverse arrangement with the finger carried by the cutting support batten and being housed in a notch formed in the cutting support block in order to ensure the translational stop.

Likewise, it is possible to envisage a reverse arrangement between the magnet 28 and the metal insert 30, namely a magnet integrated into the cutting support batten and the metal insert integrated into the cutting support block.

Moreover, whatever the embodiment, the first lateral end 10b, 10b′, 10b″ of the baseplate 10-1 to 10-5 of the cutting support block 4-1 to 4-5 (or of the unitary comb element) advantageously comprises contactless identification means. For example, these means can be an RFID tag allowing the cutting support block (or the unitary cutting support element, if applicable) to be identified individually or in batches.

It will also be noted that, whatever the embodiment, the baseplate 10-1 to 10-5 of the cutting support block 4-1 to 4-5 (or of the unitary comb element) is provided with holes to allow the passage of the suction air, so that it is necessary that the upper face of the cutting support batten 6-1 to 6-5, the metal insert and the magnet used to ensure the holding by magnetism are also provided with holes for the passage of suction air (or they are arranged to allow this passage of air).

1-12. (canceled)

13. A device for assembling a modular cutting support element on a cutting support batten of a conveyor cutting machine for cutting sheet materials, comprising:
a cutting support batten intended to be secured to a conveyor of the cutting machine,
at least one modular cutting support element comprising a plurality of bristles each having a foot secured to a baseplate and a head opposite to the foot on which a sheet material to be cut is intended to rest, and
means for vertically holding by magnetism at least part of the baseplate of the modular cutting support element on at least part of the cutting support batten.

14. The device according to claim 13, wherein the cutting support batten comprises at a first lateral end a hook and the baseplate of the modular cutting support element comprises at a first lateral end a hook able to cooperate with the hook of the cutting support batten to ensure the lateral and vertical holding of the modular cutting support element on the cutting support batten.

15. The device according to claim 14, further comprising means for laterally holding a second lateral end of the baseplate of the modular cutting support element against a second lateral end of the cutting support batten.

16. The device according to claim 15, wherein the second lateral end of the baseplate of the modular cutting support element comprises a protruding lug and the second lateral end of the support batten comprises a protruding abutment able to cooperate with the lug of the baseplate of the modular cutting support element so as to allow lateral holding of the second lateral end of the baseplate of the modular cutting support element against the second lateral end of the cutting support batten.

17. The device according to claim 15, wherein the second lateral end of the baseplate of the modular cutting support element comprises a recessed notch and the second lateral end of the support batten comprises a protruding abutment able to cooperate with the notch of the baseplate of the modular cutting support element so as to allow lateral holding of the second lateral end of the baseplate of the modular cutting support element against the second lateral end of the cutting support batten.

18. The device according to claim 14, wherein the baseplate of the modular cutting support element comprises a magnet positioned at least at a second lateral end and the cutting support batten comprises a metal insert positioned at least at a second lateral end so as to allow vertical holding by magnetism of the second lateral end of the baseplate of the modular cutting support element on the second lateral end of the cutting support batten.

19. The device according to claim 18, wherein the magnet of the baseplate of the modular cutting support element is common for a plurality of adjacent modular cutting support elements.

20. The device according to claim 18, wherein the magnet extends between the two lateral ends of the modular cutting support element and is provided with holes for the passage of air.

21. The device according to claim 14, wherein the baseplate of the modular cutting support element comprises a metal insert positioned at least at a second lateral end and the cutting support batten comprises a magnet positioned at least at a second lateral end so as to allow vertical holding by magnetism of the second lateral end of the baseplate of the modular cutting support element on the second lateral end of the cutting support batten.

22. The device according to claim 14, wherein the first lateral end of the cutting support batten corresponds to an upstream end relative to the direction of advance of the conveyor of the cutting machine.

23. The device according to claim 14, wherein the first lateral end of the baseplate of the modular cutting support element further comprises contactless identification means.

24. The device according to claim 13, wherein the modular cutting support element is a modular comb element or a cutting support block.
